(19) United States
(12) Patent Application Publication
(10) Pub. No.: US 2025/0016735 A1
(43) Pub. Date: Jan. 9, 2025

(54) Empirical and Adaptive Paging Policy

(71) Applicant: Parallel Wireless, Inc., Nashua, NH (US)

(72) Inventors: Mansoorali Kudsi, Bangalore (IN); Anoop Gupta, Pune (IN); Vivek Pise, Pune (IN)

(21) Appl. No.: 18/766,646

(22) Filed: Jul. 8, 2024

Related U.S. Application Data
(60) Provisional application No. 63/512,518, filed on Jul. 7, 2023.

(51) Int. Cl. H04W 68/00

(52) U.S. Cl. CPC H04W 68/00

(57) ABSTRACT

An intelligent scheme is proposed for the network to keep reconfiguring and re-tuning itself to achieve an optimal paging policy without requiring manual intervention. The scheme will allow the network to automatically devise a paging policy to adapt to the network deployment in place and as per the mobility pattern of users in the area covered by a particular CELL tower during different times of the day.

### CROSS-REFERENCE TO RELATED APPLICATIONS

The present application claims the benefit of priority under 35 U.S.C. § 119(e) to U.S. Provisional Patent Application No. 63/512,518, having the same title as the present application and filed Jul. 7, 2023, which is also hereby incorporated by reference in its entirety for all purposes.

The present application also hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03).

This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019. This application also incorporates by reference the U.S. patent application having docket number PWS-72749US01, filed 2022 Aug. 16 with application Ser. No. 17/819,950 and title “4G/5G Open RAN CU-UP High Availability Solution”; the U.S. patent application having docket number PWS-72754US01, filed 2022 Dec. 19 with application Ser. No. 18/068,520 and title “CU-CP High Availability”; and the U.S. patent application having docket number PWS-72765US01, filed 2022 Dec. 29 with application Ser. No. 18/148,432 and title “Singleton Microservice High Availability.” The following documents are also incorporated by reference in their entirety: the most recent version of the 3rd Generation Partnership Project (3GPP) Technical Specifications (TS) 36.413, 36.331, and 38.855 as of Jun. 9, 2023.

### BACKGROUND

Paging is a procedure used to determine the exact location of a UE so as to establish a connection to it for various services like incoming voice call, downlink data etc. Typically, paging is performed in stages where initially the UE is paged in the most probable location at Cell level (PHASE 1) and eventually spreading out to a larger paging area if UE does not respond in time from previous stage (PHASE 2).

Open RAN is the movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligent Controller). Below is the Open RAN architecture as defined by ORAN alliance.

CU function is split into CU-CP (Control Plane) and CU-UP (User Plane) function to provide Control and User Plane separation. Open RAN solution needs to support: Open Interfaces between different functions; Software based functions; Cloud Native functions; Intelligence support via support for xApps/rApps; 3^{rd} Party RRHs; Disaggregated functions; White Box COTS hardware support; and Data Path separated from Control plane traffic.

### SUMMARY

An intelligent scheme is proposed for the network to keep reconfiguring and re-tuning itself to achieve an optimal paging policy without requiring manual intervention. The scheme will allow the network to automatically devise a paging policy to adapt to the network deployment in place and as per the mobility pattern of users in the area covered by a particular cell tower during different times of the day.

In one embodiment, a method is disclosed for tuning a paging algorithm in a cellular network, comprising: collecting statistics for paging responses over a period of time within a first cell and within a neighboring set of cells proximate to (i.e., nearby) the first cell; determining a first paging area during a first paging phase, the first paging phase being for the first cell, based on a first ratio of successful paging responses received from the first cell itself versus from the neighboring set of cells during the first paging phase; determining a first paging timeout during the first paging phase for the first cell, based on a second ratio of successful paging responses terminating during the first paging phase versus successful paging responses terminating during a subsequent stage.

The method may further comprise: determining a second paging area during a second paging phase, the second paging phase being for the first cell, the second paging area being determined to be all cells within the location area of the first cell; and determining a second paging timeout during the second paging phase for the first cell.

The method may further comprise disabling a second paging phase if each cell in the neighboring set of cells belongs to a different location area than the first cell. The method may further comprise resetting the first paging area and the first paging timeout after a period of time. The method may further comprise adjusting the first paging area and the first paging timeout by repeating the steps of determining the first paging area and determining the first paging timeout after a period of time with additional collected statistics.

In another embodiment, a non-transitory computer-readable medium is disclosed containing instructions which, when executed on a processor, cause the processor to perform steps including: collecting statistics for paging responses over a period of time within a first cell and within a neighboring set of cells proximate to (nearby) the first cell; determining a first paging area during a first paging phase, the first paging phase being for the first cell, based on a first ratio of successful paging responses received from the first cell itself versus from the neighboring set of cells during the first paging phase; determining a first paging timeout during the first paging phase for the first cell, based on a second ratio of successful paging responses terminating during the first paging phase versus successful paging responses terminating during a subsequent stage.

In the non-transitory computer-readable medium, the instructions may further comprise: determining a second paging area during a second paging phase, the second paging phase being for the first cell, the second paging area being determined to be all cells within the location area of the first cell; and determining a second paging timeout during the second paging phase for the first cell.

In the non-transitory computer-readable medium, the instructions may further comprise disabling a second paging phase if each cell in the neighboring set of cells belongs to a different location area than the first cell. In the non-transitory computer-readable medium, the instructions may further comprise resetting the first paging area and the first paging timeout after a period of time. In the non-transitory computer-readable medium, the instructions may further comprise adjusting the first paging area and the first paging timeout by repeating the steps of determining the first paging area and determining the first paging timeout after a period of time with additional collected statistics.

### BRIEF DESCRIPTION OF THE DRAWINGS

FIG. 1 is a schematic diagram of a legacy RAN deployment architecture, as known in the prior art.

FIG. 2 shows a schematic diagram of radio functional splits showing split 7.

FIG. 3 is a schematic diagram of an Open RAN 4G/5G deployment architecture, as known in the prior art.

FIG. 4 is a first schematic diagram of a multi-RAT RAN deployment architecture, in accordance with some embodiments.

FIG. 5 is a second schematic diagram of a multi-RAT RAN deployment architecture, in accordance with some embodiments.

FIG. 6 is a schematic diagram of a multi-RAT RAN deployment architecture, in accordance with some embodiments.

FIG. 7 is a fourth schematic diagram of a multi-RAT RAN deployment architecture, in accordance with some embodiments.

FIG. 8 is a fifth schematic diagram of a multi-RAT RAN deployment architecture, in accordance with some embodiments.

FIG. 9 is a schematic diagram of a multi-RAT RAN deployment in operation, in accordance with some embodiments.

FIG. 10 is a schematic diagram of an OpenRAN core architecture, in accordance with some embodiments.

FIG. 11 shows a schematic diagram 1100 of a CU-CP Open RAN architecture, in accordance with a 5G architecture.

FIG. 12 shows a CU-CP internal logical architecture and internal nodes shown as microservices, in accordance with some embodiments.

FIG. 13 is a schematic diagram of a microservice control architecture, in accordance with some embodiments.

FIG. 14 is a schematic diagram of an SCTP microservice, in accordance with some embodiments.

FIG. 15 is a flowchart showing paging policy determination, in accordance with some embodiments.

### DETAILED DESCRIPTION

An intelligent scheme is proposed for the network to keep reconfiguring and re-tuning itself to achieve an optimal paging policy without requiring manual intervention. The scheme will allow the network to automatically devise a paging policy to adapt to the network deployment in place and as per the mobility pattern of users in the area covered by a particular CELL tower during different times of the day.

Paging comprises of a majority of control plane traffic in the network. It is important to throttle these paging messages so that they do not hog the network bandwidth. It is also important to have an intelligent paging mechanism which will help the network to reach out to the UE quickly. During the course of the paging procedure, a radio controller node maintains a context for each paging request and runs the timers as per the configured paging policy. It is good to have a paging policy which will help in reaching out to the UE and release the resources maintained for the paging procedure as soon as possible. In case of a mixed kind of deployment where some cells have neighbors, which belong to the same Location Area as it and some cells have neighbors which don't belong to the same Location Area, it is desirable to have the right paging policy at a per cell ID level. Each deployment is different and the mobility patterns of UEs differ from place to place and during different times of the day. Operator may determine and manually configure the right paging policy for each cell site based on all affecting parameters.

In one embodiment, a paging policy is configured on the Radio Controller Node (BSC/NodeB/eNodeB/gNB/Femto-Gateway, or near-RT RIC/MME) which includes configurable to enable or disable each paging stage and the timeout values for each stage. A paging policy typically consists of following information, in some embodiments: Phase 1 to N enabled/disabled; Phase 1 to N paging area scope; Phase 1 to N timeout.

The outcome of a paging procedure is affected by various parameters like: location area (RAC/LAC/TAC) of neighboring CELLs; mobility pattern of UEs in a particular CELL; DRX cycle configuration on the UEs; the Paging Policy configured on the Network nodes, in some embodiments.

The idea is to define an adaptive and empirical paging policy for the Radio Controller Node which will keep reconfiguring itself based on empirical data derived out of the pattern of mobility of UEs within and out of a particular Cell. The operator need not bother about tuning the paging policy parameters as the system will keep tuning itself to adapt to the deployment scenario on a per cell basis.

Thus, in using the pattern of successful UE pages, the system can fine-tune itself to derive the optimum paging policy for a given cell.

The scope of the paging policy involves the values of the timers and the area within which paging is performed, in some embodiments. As a result of the system auto-tuning itself, the operator will be relieved of the task to manually determine and configure an appropriate paging policy for each cell individually.

Scenario 1: Location area of neighboring cells—Neighbors belonging to the same Location Area.

In some embodiments, in a deployment scenario where neighboring cells belong to the same location area (LAC/RAC/TAC), an IDLE UE moving between such cells does not inform the network of the change in the cell. As a result, the exact location of the UE at cell level is not known to the network. On the other hand, a connected UE informs the network of change in cell and hence the network knows the exact location of the UE. Since the exact CELL location of the UE may not be known, the paging can be performed in phases based on the last known cell of the UE.

Scenario 2: Location area of neighboring cells—Neighbors belonging to different Location Areas

In some embodiments, in a deployment scenario where neighboring cells do NOT belong to the same location area (LAC/RAC/TAC), a UE moving between such cells keeps informing the network of the change in cell ID. As a result, the exact location of the UE at cell level is always known to the network.

Scenario 3: Mixed

In case of a mixed kind of deployment where some cells have neighbors, which belong to the same Location Area and some cells have neighbors which don't belong to the same Location Area, we need to have the right paging policy at a per cell ID level.

During the course of the paging procedure, the Radio Controller node maintains a context for each paging request and runs the timers as per the configured paging policy.

### Algorithm for Auto-Tuning

The different phases of paging can be fine tuned to adapt to the network deployment and mobility pattern of UEs in the geographical area covered by the CELL tower, in accordance with the following description in some embodiments.

Paging area during phase 1. Typically, scope of paging area during the phase 1 of paging is the last known cell and its neighbor cells as well. If a ratio of successful versus unsuccessful paging responses is calculated and/or stored, and most of the successful paging responses are happening from the last known cell itself, it means there is less mobility of end users in that geographical area and system shall skip doing paging in the neighbor cells during phase 1. On the contrary, if the ratio of successful versus unsuccessful paging responses is calculated and most of the paging responses are coming from neighboring cells of last known cell, then the phase 1 paging can include neighboring cells. This insight can be used to derive helpful and actionable information for the algorithm.

Paging timeout during phase 1. The responses of paging requests can be identified by their origin. If most of the paging requests are going into phase 2, but the responses are coming from the last known cell of the UEs or its neighbors, it means that network is not waiting long enough for a response from the UEs during phase 1; this can also be calculated and/or stored as a ratio. So, the paging timeout value of phase 1 shall be increased by appropriate amount in that case, such as incrementally increasing using a backoff algorithm. If the paging responses are coming in in quite lesser time as compared to the configured phase 1 paging timeout value, network shall reduce the timeout value appropriately so as to quickly move to phase 2 for timeouts during phase 1.

Paging area during phase 2. Scope of paging area during the phase 2 of paging is the set of all cells belonging to the same Location Area. During phase 2, the following decisions may be computed and the following steps may be performed, in some embodiments.

Paging area during phase 2—Disabling Phase 1. If the mobility of UEs is quite high within a particular geographical area (based on number of UEs that are handed in or out, potentially calculated as a ratio based on the total number of UEs seen) and most of the phase 1 paging requests are failing (calculated as a ratio), then network can disable phase 1 and directly go to phase 2 of larger paging area so as to avoid wasting time performing phase 1 paging, in some embodiments. The neighbor cells can be learned dynamically using statistics of successful handoffs within and out of a particular cell. This may be done using online or offline machine learning (ML) training, or manually, or by a combination of manual and ML, where ML is based on origination or destination of handover, for example. Neighbor cells can be retrieved from the network or can be sent in a message from the network to the radio controller node.

Paging area during phase 2—Disabling Phase 2. If all the neighbor cells of a particular cell belong to a different location area, then the phase 2 shall be disabled. Also, the phase 1 shall include only last known cell and not its neighbors.

Paging area during phase 2—Resetting optimizations. All the different optimizations discussed till now will be periodically reset and re-tuned, for example, every half an hour so as to adapt to varying patterns of mobility of users in a particular cell during different times of the day. Different periods are also possible. This will also help to adjust to newer neighboring deployments to existing ones like addition of a new radio tower in neighborhood of existing set of radio towers.

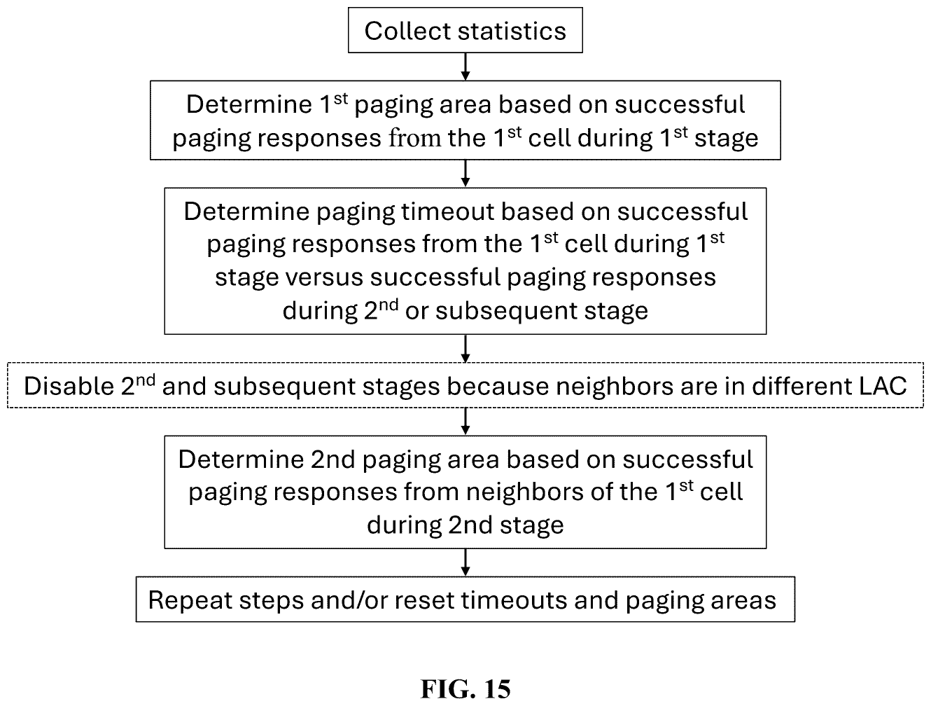

FIG. 15 is a flowchart showing paging policy determination, in accordance with some embodiments, showing the steps described in the preceding paragraphs. Dotted lines re disabling 2^{nd} and subsequent stages reflects that this stage is optional, in some embodiments.

### Additional Embodiments

In some embodiments, learning the neighboring cells using successful handovers is described above. From which cell are UEs typically responding, for instance. This information may also be learned and used. If neighbor RACs/LACs/TACs are different, do not do phase 2 paging, in some embodiments. ML or manual learning can be used. Period of times such as ten minutes, half an hour, an hour, six hours, twelve hours, a day, a week etc. may be used for measuring, training, and collecting statistics.

In some embodiments, the functionality may be provided as modular or containerized functionality at the network core. In some embodiments, the functionality may be provided as xApps at a near-RT RIC, or rApps at a non-RT RIC, or in a combination of xApps and rApps that are in communication with each other and with the base station. In some embodiments, the functionality may be provided partially or wholly using a machine learning data lake or data pipeline. In some embodiments, provision of the functionality may be provided using different nodes in the network for different RATs, e.g., a non-RT RIC for 5G and a LAC or MME for 4G. In some embodiments, an OpenRAN or a non-OpenRAN deployment architecture may be supported.

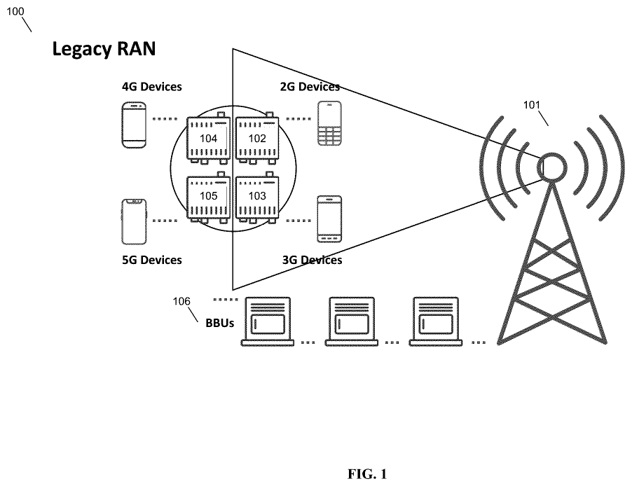

FIG. 1 is a schematic diagram of a legacy RAN deployment architecture, as known in the prior art. Radio tower 101 is used for co-locating a 2G base station 102, 3G base station 103, 4G base station 104, and 5G base station 105, each individual RAT base station having its own radio(s) and processing. To support and enable the radios to perform their necessary functions, including PHY, MAC, backhaul, RRC, etc., several base band units (BBUs) 106 are typically located at the base of the tower and are connected to the individual RAT base stations using a physical cable. This cable itself introduces signal loss and heat/power wastage. The BBUs themselves are expensive to purchase and deploy to the site, are expensive to operate given their need for real estate, HVAC and electrical support, and are expensive also to maintain, as a typical maintenance activity requires a dedicated truck roll to the site with a skilled technician.

### Radio Unit Functional Splits

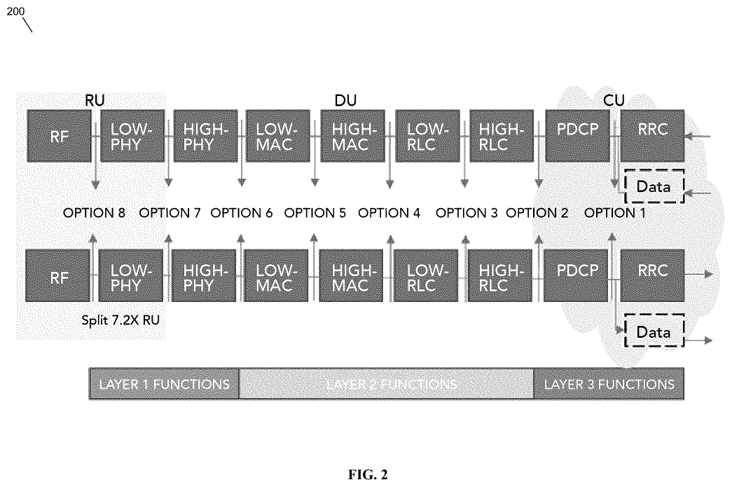

FIG. 2 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (Dus) and Centralized Units (Cus), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple Dus will support multiple gNBs. The split architecture lets a 5G network utilize different distributions of protocol stacks between CU and Dus depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

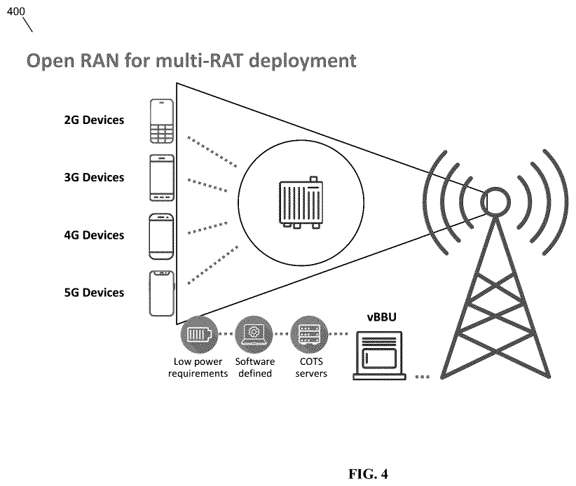

When the RAN functional split architecture (FIG. 4) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety. The present systems and methods are used with Option 7.2 or with other functional splits, and with 2G, 4G, 5G DU/CU, or a combination thereof, in some embodiments.

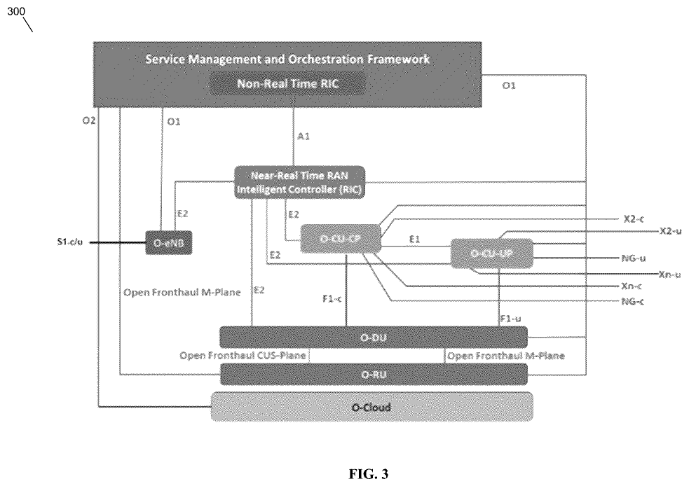

FIG. 3 is a schematic diagram of an Open RAN 4G/5G deployment architecture, as known in the prior art. The O-RAN deployment architecture includes an O-DU and O-RU, as described above with respect to FIG. 2, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination. As well, a non-real time RAN intelligent controller is shown, receiving inputs from throughout the network and specifically from the near-RT RIC and performing service management and orchestration (SMO), in coordination with the operator's network (not shown).

FIG. 4 is a first schematic diagram of a multi-RAT RAN deployment architecture, in accordance with some embodiments. FIG. 4 shows a radio tower with a remote radio head (RRH) supporting multiple RATs, 2G/3G/4G/5G, but without requiring four generations of radio base stations as shown in FIG. 1. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in FIG. 1 have been replaced with one or more vBBUs, baseband units that are rearchitected to use modern virtualization technologies. FIG. 4 can be enabled using a technology like CPRI or eCPRI, which enables digitization and transfer of radio I/Q samples for further processing at a BBU or vBBU. The present systems and methods are used with any RAN such as shown, including a multi-RAT RRH, in some embodiments.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

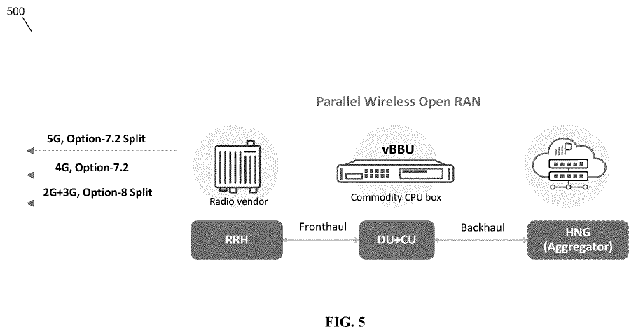

FIG. 5 is a second schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU. The present systems and methods are used with any RAN such as shown, including a multi-RAT RRH, in some embodiments. Specifically, the paging algorithms can be used with these RANs and/or can be sent to the RANs for implementation, in some embodiments.

Continuing with FIG. 5, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core. The paging algorithms can be performed at the HNG, which is a radio controller node, in some embodiments.

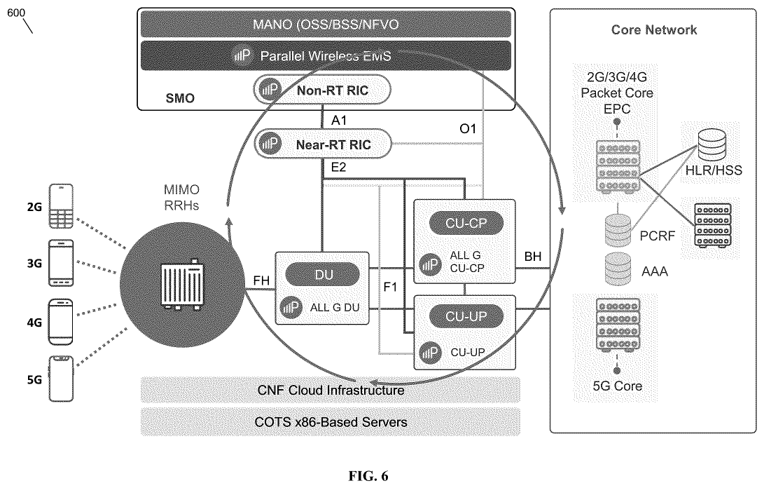

FIG. 6 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments. Specifically, the paging algorithms can be performed at the all-G near-RT RIC, in some embodiments, including by xApps, in some embodiments.

(Open RAN) is a movement in wireless telecommunications to Open Radio Access Network disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

The first RAT may be 4G or 5G, and The radio fronthaul interface may be Common Public Radio Interface (CPRI) or Enhanced Common Public Radio Interface (eCPRI). The second RAT may be 2G or 3G, and The radio fronthaul interface may be Common Public Radio Interface (CPRI) or Enhanced Common Public Radio Interface (eCPRI). The first and the second functional RU may be colocated on a single physical device and virtualized to operate as separate processes. The first and the second functional RU may be instantiated as virtualized containers.

The multi-RAT non-RT RIC may be coupled to a network operator service management and orchestration (SMO) functionality. The method may further comprise a multi-RAT central unit control plane (CU-CP) and multi-RAT central unit user plane (CU-UP). The SMO functionality may provide, e.g., a list of base stations or cells, or communication information to reach other cells or RICs. Specifically, the paging algorithms described herein can be performed at the all-G near-RT RIC, in some embodiments, or the multi-RAT non-RT RIC, in some embodiments.

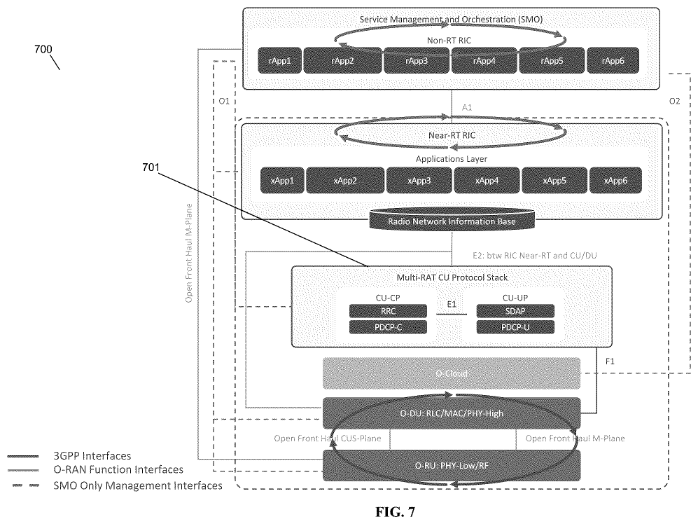

FIG. 7 is a fourth schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

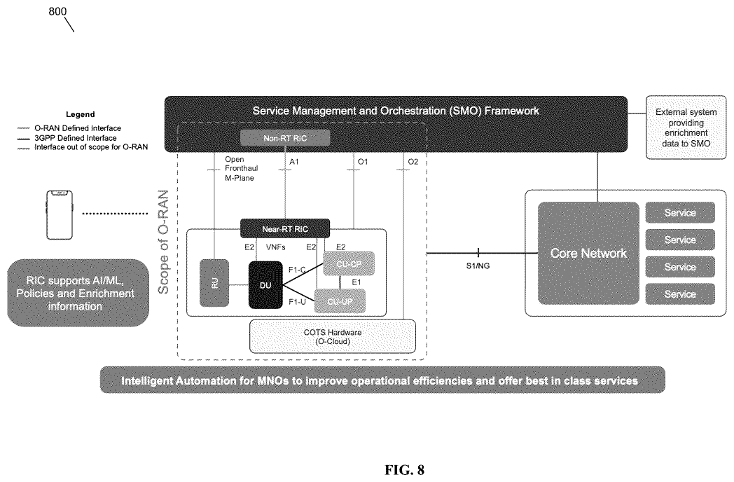

FIG. 8 is a fifth schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for AI/ML that involve adjustments that operate outside of the UE latency window (for 4G/5G˜100 ms), in some embodiments.

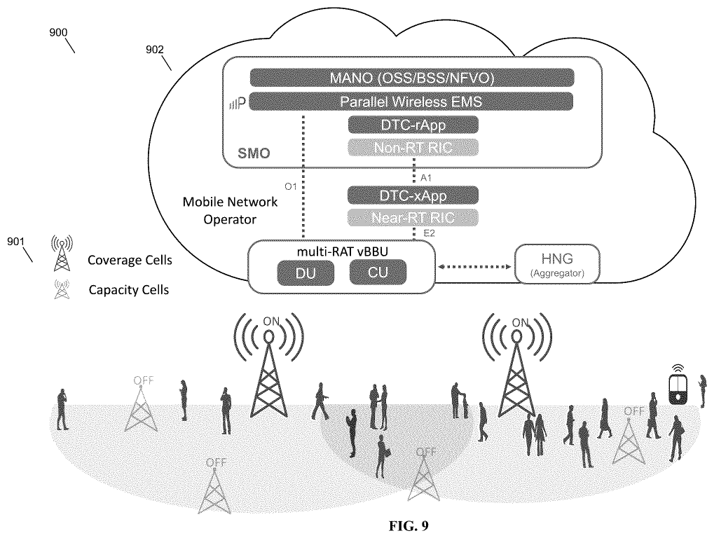

FIG. 9 is a schematic diagram of a multi-RAT RAN deployment in operation, in accordance with some embodiments. Diagram 901 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 902 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OSS/BSS/NFVO) for network operational capabilities. The coverage and capacity cells shown in 901 are in communication with the all-G near-RT RIC and all-G non-RT RIC. Network functions are managed by applications, called xApps when running on the near-RT RIC and rApps when running on the non-RT RIC, and these applications are in communication with each other and aware of the network conditions through information available at the systems on which they are running.

In operation, for some embodiments, for example, when a coverage cell is heavily loaded, an rApp on the non-RT RIC and an xApp on the near-RT RIC coordinate to assess paging, which can include identifying an appropriate capacity cell to activate; activating the cell; and handing over users from the coverage cell to the newly active cell. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments. ML training may be performed at the non-RT RIC, in some embodiments, and may be performed on a nightly, weekly, or otherwise periodic basis.

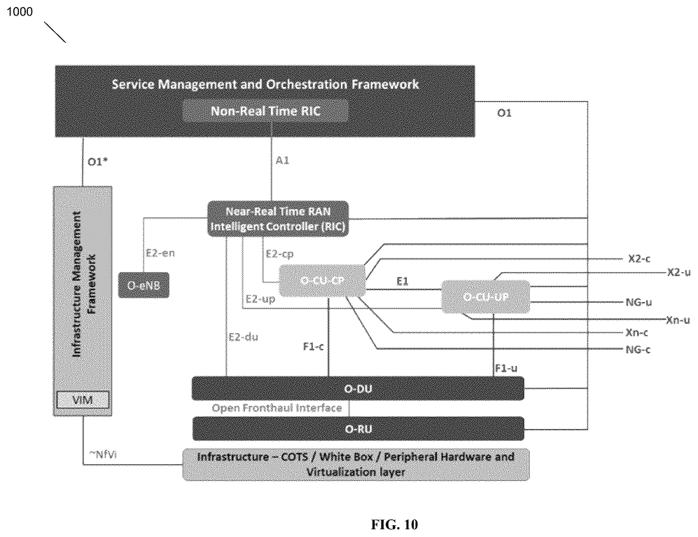

FIG. 10 is a schematic diagram of an OpenRAN core architecture, in accordance with some embodiments. The present disclosure is enabled for use with the disclosed architecture in this figure. Various nodes, for example the CU-CP and CU-UP nodes (here marked O-CU-CP and O-CU-UP to denote OpenRAN-compatible nodes), use SCTP and may use the methods and systems described herein for SCTP high availability. The node marked “Infrastructure—COTS/White Box/Peripheral Hardware and Virtualization Layer” may, in some embodiments, use the containerized architecture described herein and may use SCTP high availability features to provide this functionality to any of the higher layers and nodes, e.g., O-XXX, Near-RT RIC, etc. of this architecture as shown in the figure, in some embodiments.

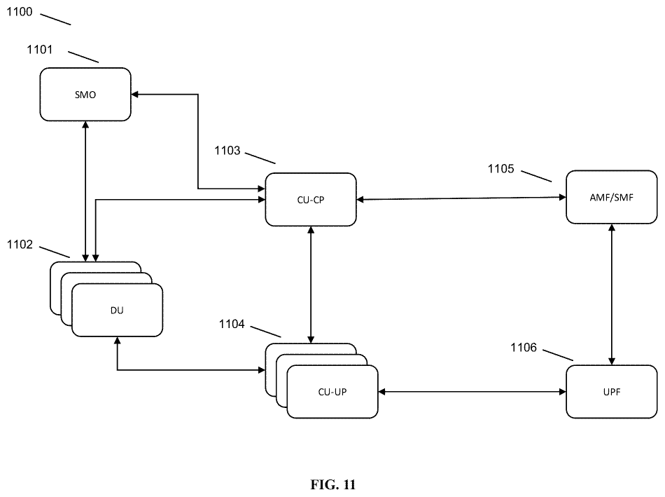

FIG. 11 shows a schematic diagram 1100 of a CU-CP Open RAN architecture, in accordance with a 5G architecture. CU-CP 1103 is in communication with a plurality of DUs 1102, with one or more CU-UPs 1104, service management and orchestration node (SMO) 1101, and AMF/SMF 1105. UPF 1106 is also in communication with AMF/SMF and CU-UP.

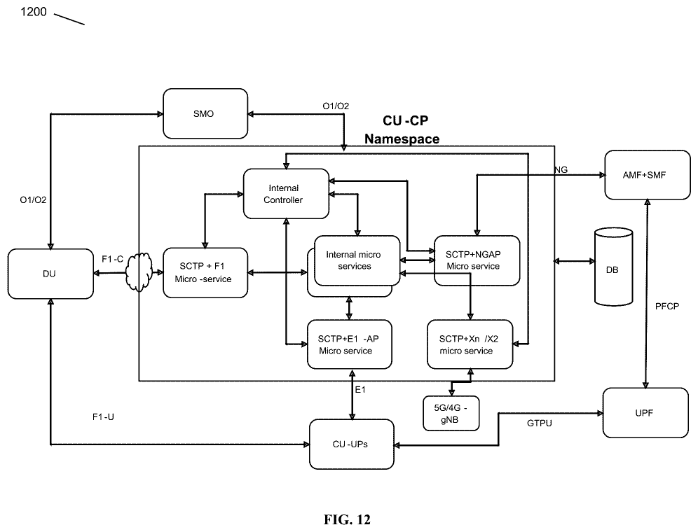

FIG. 12 shows a CU-CP internal logical architecture and internal nodes shown as microservices, in accordance with some embodiments. A variety of microservices provide the benefits of a microservices-based architecture, such as massively parallel processing, restart and management and availability, advanced monitoring, etc. This microservices architecture enables 4G and 5G, as shown, and can be readily extended to 2G and 3G as well (not shown). All of these nodes can use microservices, in some embodiments. However, although a microservice architecture provides high availability and scalability for stateless services seamlessly, it is noted that a session created on SCTP association can be lost if one of the SCTP pods (microservices) crashes and existing connection are not restored in time-bound manner.

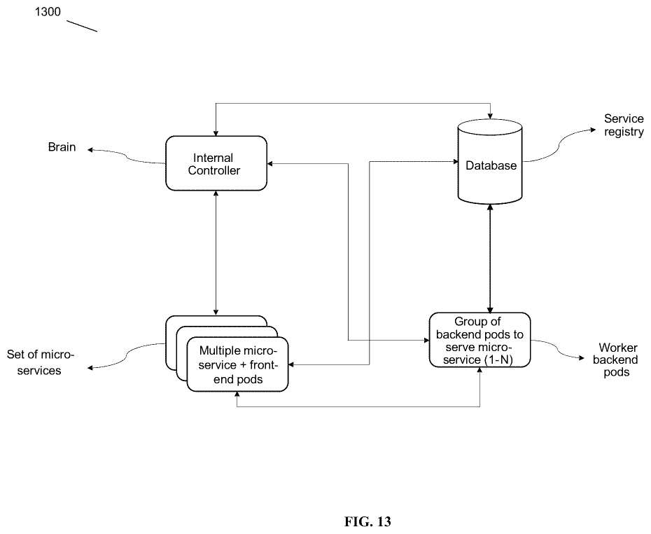

FIG. 13 is a schematic diagram of a microservice control architecture, in accordance with some embodiments. Shown is a schematic diagram showing a pod microservice logical architecture with front and back-end pods, in accordance with some embodiments. A plurality of front-end pods for terminating connections and back-end pods for handling and processing traffic is in communication with a database; the database handles registration of the pods as described below. Other nodes, such as peer nodes, interface with the microservice via a particular service IP, and routing is performed within the microservice to the front end pods and back end pods, in some embodiments by a routing pod.

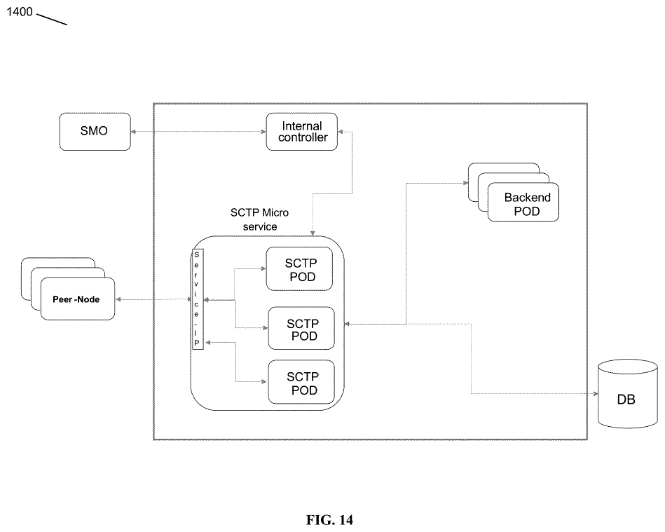

FIG. 14 is a schematic diagram of an SCTP microservice, in accordance with some embodiments. An active-active model is shown, wherein one microservice is the primary and another microservice is the backup, with both being active and the backup ready to take over at any time.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, Python, Rust, Go, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for tuning a paging algorithm in a cellular network, comprising:
collecting statistics for paging responses over a period of time within a first cell and within a neighboring set of cells proximate to the first cell;
determining a first paging area during a first paging phase, the first paging phase being for the first cell, based on a first ratio of successful paging responses received from the first cell itself versus from the neighboring set of cells during the first paging phase;
determining a first paging timeout during the first paging phase for the first cell, based on a second ratio of successful paging responses terminating during the first paging phase versus successful paging responses terminating during a subsequent stage.

2. The method of claim 1, further comprising:
determining a second paging area during a second paging phase, the second paging phase being for the first cell, the second paging area being determined to be all cells within the location area of the first cell; and
determining a second paging timeout during the second paging phase for the first cell.

3. The method of claim 1, further comprising disabling a second paging phase if each cell in the neighboring set of cells belongs to a different location area than the first cell.

4. The method of claim 1, further comprising resetting the first paging area and the first paging timeout after a period of time.

5. The method of claim 1, further comprising adjusting the first paging area and the first paging timeout by repeating the steps of determining the first paging area and determining the first paging timeout after a period of time with additional collected statistics.

6. A non-transitory computer-readable medium containing instructions which, when executed on a processor, cause the processor to perform steps including:
collecting statistics for paging responses over a period of time within a first cell and within a neighboring set of cells proximate to the first cell;
determining a first paging area during a first paging phase, the first paging phase being for the first cell, based on a first ratio of successful paging responses received from the first cell itself versus from the neighboring set of cells during the first paging phase;
determining a first paging timeout during the first paging phase for the first cell, based on a second ratio of successful paging responses terminating during the first paging phase versus successful paging responses terminating during a subsequent stage.

7. The non-transitory computer-readable medium of claim 6, the instructions further comprising:
determining a second paging area during a second paging phase, the second paging phase being for the first cell, the second paging area being determined to be all cells within the location area of the first cell; and
determining a second paging timeout during the second paging phase for the first cell.

8. The non-transitory computer-readable medium of claim 6, the instructions further comprising disabling a second paging phase if each cell in the neighboring set of cells belongs to a different location area than the first cell.

9. The non-transitory computer-readable medium of claim 6, the instructions further comprising resetting the first paging area and the first paging timeout after a period of time.

10. The non-transitory computer-readable medium of claim 6, the instructions further comprising adjusting the first paging area and the first paging timeout by repeating the steps of determining the first paging area and determining the first paging timeout after a period of time with additional collected statistics.
